(19) United States
(12) Patent Application Publication
(10) Pub. No.: US 2019/0156395 A1
(43) Pub. Date: May 23, 2019

(54) System and Method for Analyzing and Searching for Features Associated with Objects

(71) Applicant: 9206868 Canada Inc., Montreal (CA)

(72) Inventors: Maria Carolina BESSEGA, Montreal (CA); Jaime Rafael CAMACARO, Montreal (CA)

(21) Appl. No.: 16/253,789

(22) Filed: Jan. 22, 2019

Related U.S. Application Data
(63) Continuation of application No. PCT/CA2017/000176, filed on Jul. 24, 2017.
(60) Provisional application No. 62/365,436, filed on Jul. 22, 2016.

(51) Int. Cl. G06Q 30/06; G06F 16/56; G06F 16/51; G06F 16/9535; G06F 16/9538; G06N 3/08

(52) U.S. Cl. CPC G06Q 30/0631; G06F 16/56; G06N 3/08; G06F 16/9535; G06F 16/9538; G06F 16/51

(57) ABSTRACT

There is provided a system and method for analyzing features associated with objects. The method comprises obtaining one or more images associated with corresponding one or more objects; passing each image through a plurality of models to generate feature vectors for each object; combining feature vectors for each object when multiple feature vectors are produced; generating similarity measures for the feature vectors; and storing the feature vectors to enable the features to be searched, filtered and/or retrieved.

### CROSS-REFERENCE TO RELATED APPLICATION

This application is a continuation of PCT Application No. PCT/CA2017/000176 filed on Jul. 24, 2017 which claims priority from U.S. Provisional Patent Application No. 62/365,436 filed on Jul. 22, 2016, the contents of both incorporated herein by reference.

### TECHNICAL FIELD

The following relates to systems and methods for analyzing and searching for features associated with objects.

### DESCRIPTION OF THE RELATED ART

Online shopping and e-commerce in general is becoming more popular and more common. While users are accessing and interacting with a particular merchant's website, various techniques may be used by the merchant (or a third party service) to entice shoppers to consider purchasing other items. For example, several e-commerce websites are known to correlate a currently searched or viewed item with items also purchased at the same time by other shoppers, in order to provide a recommendation to the user.

When assessing whether products are potentially relevant to a user, various problems may be encountered. For example, the so called “cold start” problem occurs when new users enter a site for the first time, which can make it difficult to assess what products may be relevant to that user. Another problem is that the products being sold online often change frequently and continuously, making it difficult to rely on historical interactions with a particular website. Moreover, even when such historical data is available and relevant, there is often a low volume of data from which to analyze.

It is an object of the following to address the above-noted disadvantages.

### SUMMARY

In one aspect, there is provided a method of analyzing features associated with objects, the method comprising: obtaining one or more images associated with corresponding one or more objects; passing each image through a plurality of models to generate feature vectors for each object; combining feature vectors for each object when multiple feature vectors are produced; generating similarity measures for the feature vectors; and storing the feature vectors to enable the features to be searched, filtered and/or retrieved.

In other aspects, there are provided computer readable media and systems and devices configured to perform the method.

### BRIEF DESCRIPTION OF THE DRAWINGS

Embodiments will now be described by way of example only with reference to the appended drawings wherein:

FIG. 1 is a schematic block diagram of a system for performing feature analysis and searching;

FIG. 2 is a schematic block diagram of a feature analysis and search engine;

FIG. 3 is a schematic block diagram illustrating logic performed by a deep learning engine;

FIG. 4 is a schematic diagram illustrating an example convolution neural network structure;

FIG. 5 is a flow chart illustrating computer executable instructions for generating a list of similar items using the deep learning engine;

FIG. 6 is a schematic network diagram of recommendation engine connected to a number of online merchants accessible to users operating electronic devices;

FIG. 7 is a schematic block diagram of a recommendation engine;

FIG. 8 is a flow diagram illustrating a recommendation generated based on a user's current interactions with a merchant website;

FIG. 9 is a flow diagram illustrating a recommendation generated using user information;

FIG. 10 is a flow diagram illustrating a recommendation generated using product information;

FIGS. 11(a), 11(b) and 11(c) illustrate recommendations generated based on a user's interactions with a single merchant;

FIGS. 12(a), 12(b) and 12(c) illustrate recommendations generated based on a user's interactions with multiple merchants;

FIGS. 13(a), 13(b), 13(c) and 13(d) illustrate recommendations generated for a first user based on a another user's interactions with multiple merchants; and

FIG. 14 is a flow chart illustrating computer executable instructions for generating and providing a recommendation.

### DETAILED DESCRIPTION

The following describes a feature analysis and search engine and methods for using same, that uses deep learning and other machine learning techniques, to determine extensive details about a product, by applying such deep learning and machine learning processes to media items (e.g., images, video, text) associated with the product, and other related data about the product, if available.

The results of this deep learning and machine learning processes enable the detailed features to be searched in order to find, for example, equivalent, similar or complementary products; on same site or across different merchant sites, as well as determine similar or equivalent or complementary user types to enhance applications of such a search, for example in generating recommendations provided to the users of those sites. The search on the space of features is performed using an important, but not restrictive, set of components based on elements that reflect a particular style imposed on the images as a “signature” for the images. These elements can include details like the pose taken by a model, color dynamic, textures, the existence of print patterns among others. These can be considered style factors encoded in the features, and can be exploited during the search. They can also be turned on and off individually to emphasize a particular style factor during the search.

A recommendation engine is also described herein, as one example application of the feature analysis and search engine. The recommendation engine described herein does not rely on merchants using consistent product types or having consistent, complete, or accurate metadata, since the deep learning and machine learning employed by the feature analysis and search engine used by the recommendation engine identifies features and finer details that can be extracted from the images of the products, as well as the other information available to the engine, to determine equivalent, similar and complementary products. This enables more suitable and accurate recommendations to be made, based on the user's attributes, and/or the product's attributes. The feature and search analysis engine can therefore also be used to leverage similarities between objects to enhance traditional recommendation systems, using an equivalent history matrix, described in greater detail below.

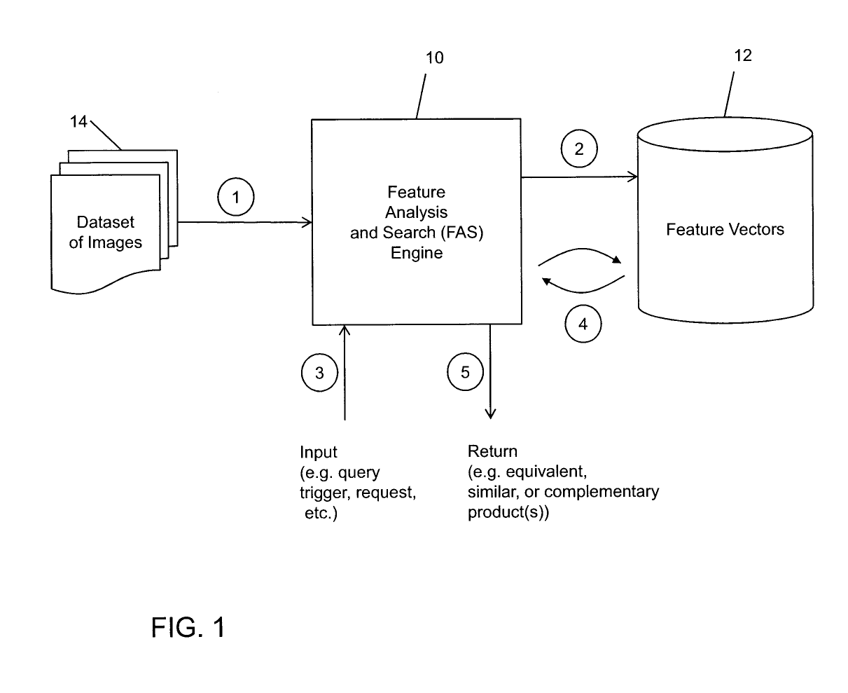

Turning now to the figures, FIG. 1 shows a feature analysis and search (FAS) engine 10 that generates feature vectors 12 related to products or other items using media items such as a dataset of images 14 for an catalogue of products being sold online. It can be appreciated that while the examples described herein may refer to analyzing images of products being sold online, the principles employed by the FAS engine 10 can be adapted for use in determining similarities between objects of any kind, using any available media items (e.g., images, video, text, etc.) to which deep learning and machine learning techniques can be applied.

In the configuration shown in FIG. 1, the dataset of images 14 is provided to the FAS engine 10 in stage 1. These images 14 are analyzed in order to generate a set of feature vectors 12 in stage 2. These feature vectors 12 can be generated offline, in real-time, or using both offline and real-time processes. For example, a website's catalogue of products being sold may have an image associated with each product. This dataset 14 can be provided to the FAS engine 10 in order to determine a granular and extensive amount of details about the products being shown in the images 14, which are indexed and made searchable in a feature vector 12 to allow for equivalent items, similar items, or complementary items to be located for various applications such as recommendations, comparing databases, etc. In stage 3, an input can be made to the FAS engine 10, for example, a search or find query, a trigger to locate items, a request, etc. The input in stage 3 is used by the FAS engine 10 to perform a search using the feature vectors in stage 4, in order to find the desired items. For example, if an equivalent item is being requested in stage 3, the feature vectors 12 can be searched to match one or more features in order to find such an equivalent. In stage 5, the results of this search are returned to the requestor or originator of the input.

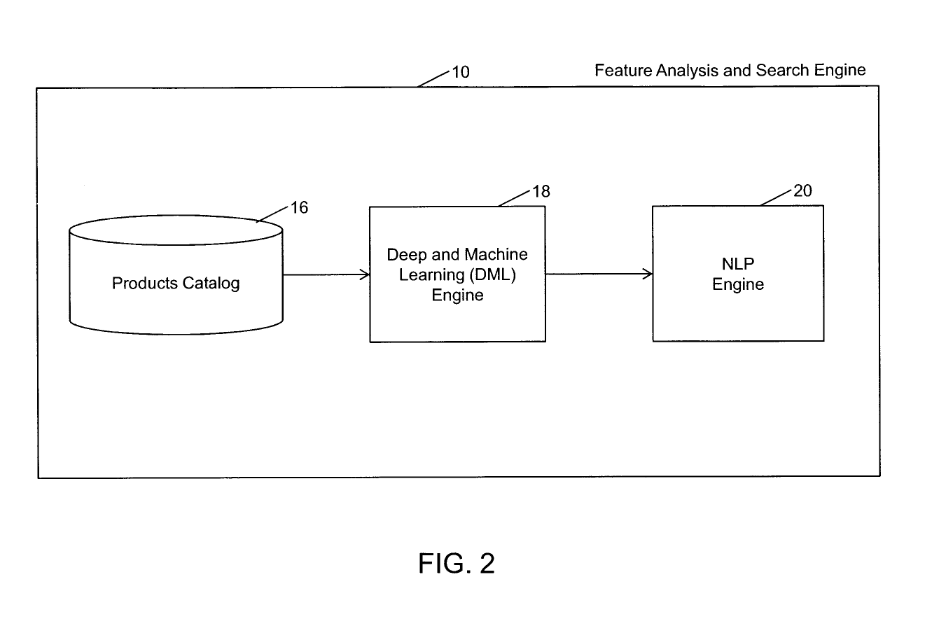

FIG. 2 provides an example of a configuration for the FAS engine 10, which uses deep learning, machine learning and natural language processing (NLP) techniques and algorithms to determine features of a product (or item) with a high dimensionality, i.e. by generating feature vectors 12 as shown in FIG. 1. The FAS engine 10 can operate in real-time, or can work offline in the background to conduct deep learning on a dataset 14 being processed, but would typically have at least a portion operated offline. For example, a dataset 14 for a merchant's website 12 can be static, but is more likely to be continually evolving and thus a baseline execution can be performed offline with updates performed in real time or periodically offline with the set of feature vectors 12 refreshed accordingly.

The FAS engine 10 includes a products catalog 16 for each database or entity for which the items are analyzed (e.g., a merchant website), in order to store the associated dataset 14. The products catalog 16 can store both actual/current and/or historical product-related data. The datasets 14 in the catalog 16 are processed by a deep and machine learning (DML) engine 18 in order to generate the feature vectors 12 for particular products and items as will be explained in greater detail below. The results generated by the DML engine 18 can be combined with results from an NLP engine 20, e.g., for processing item descriptions that correspond to the image being processed by the DML engine 18. For example, an image that corresponds to a product being sold on a merchant's website may have an item description, product reviews, metadata, search terms, and other textual data associated with the product. This data may be available on the merchant's website or via third party source (e.g. another website, product catalog, etc.). The NLP engine 20 applies NLP algorithms to optionally or selectively to obtain additional data that can improve the final result determined from the deep and machine learning techniques. For example, this can include providing another technique such as image capture and tagging. In one example use case, when the system uses additional product related data from the catalog 16 (e.g., descriptions or reviews), the system can use the NLP engine 20 as a way to enhance the results (with the image vectors left the same), i.e., to act as a complement to the image vector. For example, a sentiment analysis can be used to add another dimension to a search. In another example use case, if for some images/products the system does not have relevant additional data, such data can be generated using a Recurrent Neural Network. This data (e.g., captions or tags) can be used in the same manner as that described above with respect to the first example use case.

The products catalog 16 in this example also stores the product data that is to be analyzed by the NLP engine 20. As noted, deep learning can also be applied to image captioning, e.g., to augment, or replace the need for NLP while improving the product information.

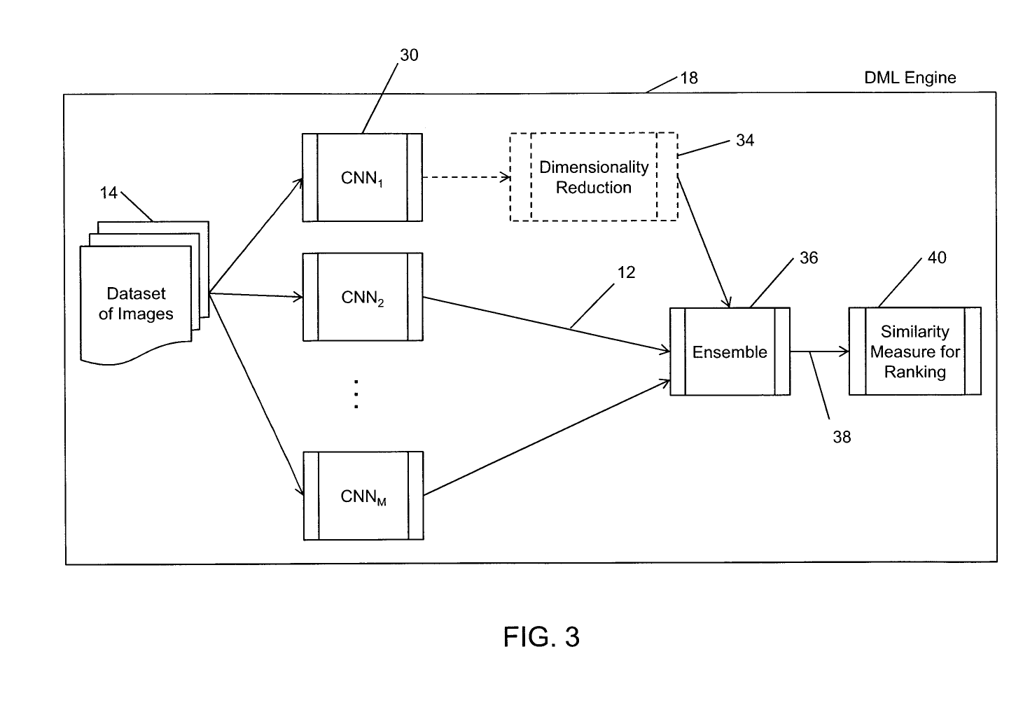

An example implementation for the DML engine 18 is shown in FIG. 3. Beginning with a dataset 14 of images (or video or other visual content), e.g., for a merchant website or other database of media items, one or more convolution neural network (CNN) models, also referred to as “ConvNets” 30 are used to apply deep learning to the dataset 14. Some example ConvNets 30 include, without limitation, AlexNet, GoogleNet, and CaffeNet. Each of the images in the dataset 14 are passed through each of the ConvNets 30. This can be done in parallel, sequentially or quasi-parallel, etc.; and the results are extracted from the last convolution layer (or in any fully connected layer except the last layer which is reserved for classification). The step of applying the ConvNets 30 generates the feature vectors 12. These feature vectors 12 are high dimensional, for example, 4096 components or 1024 components. The feature vectors 12 may be able to provide searchable attributes about the contents of the image, which allows similar features of products to be found and exploited. That is, the feature vectors 12 can enable components to be correlated to actual features and thus used to search for, compare, find, and analyze items having one or more feature vectors 12 associated therewith. The feature vectors 12, since they provide representations of the associated images, enable the system to compare full feature vectors 12 and find similar images based on the distance between the vectors.

Optionally, a principal component analysis (PCA), Restricted Boltzmann Machine (RBM), or any other method allowing dimensionality reduction, can be applied at module 34 when an ensemble of the ConvNet outputs is desired. That is, depending on the combination of ConvNets 30 being applied, the DML engine 18 should specify a common dimension for the feature vectors 12, using a method for dimensionality reduction 34. This reduces the dimension of the vectors 12 without losing information.

An ensemble 36 of ConvNets 30 is built by creating a new feature vector 38 as a linear combination of the features generated in each of the ConvNets 30. With the set of feature vectors 12 (or ensemble vectors 38), the DML engine 18 uses a similarity measure to generate a ranking 40. For example, the DML engine 18 can train a K-nearest neighbors (KNN) model 68 (e.g., by applying a Ball Tree or KD tree) to all vectors 12. Given the size of the dataset and the high dimensionality, a standard KNN algorithm can be used. The KNN model can act as a similarity search engine that includes the rankings 40 based on the similarity measured by the KNN.

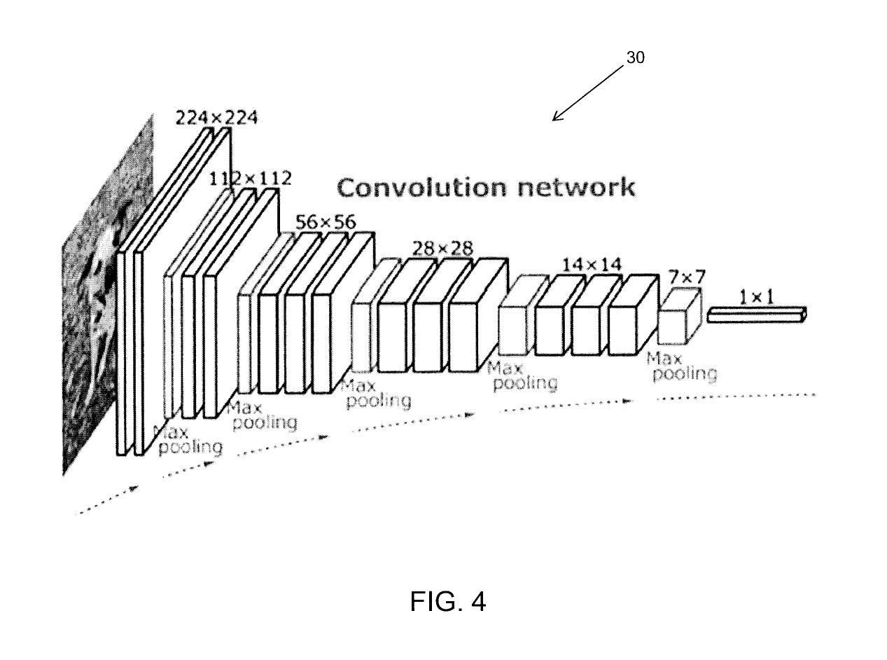

FIG. 4 illustrates an example of a structure for the ConvNets 30, in which the item being analyzed (i.e. an image in this example) is successively reduced through max pooling to identify a 1×1 feature. FIG. 4 thus illustrates a technique to obtain all features of the image. In this example, the system begins with an image of 224 pixels×224 pixels×3. Each step shown in FIG. 4 corresponds to a convolution and max pooling operation. At the end of these steps, a 1024 component vector that describes the image is obtained. That is, a 1×1×1024 data structure is obtained.

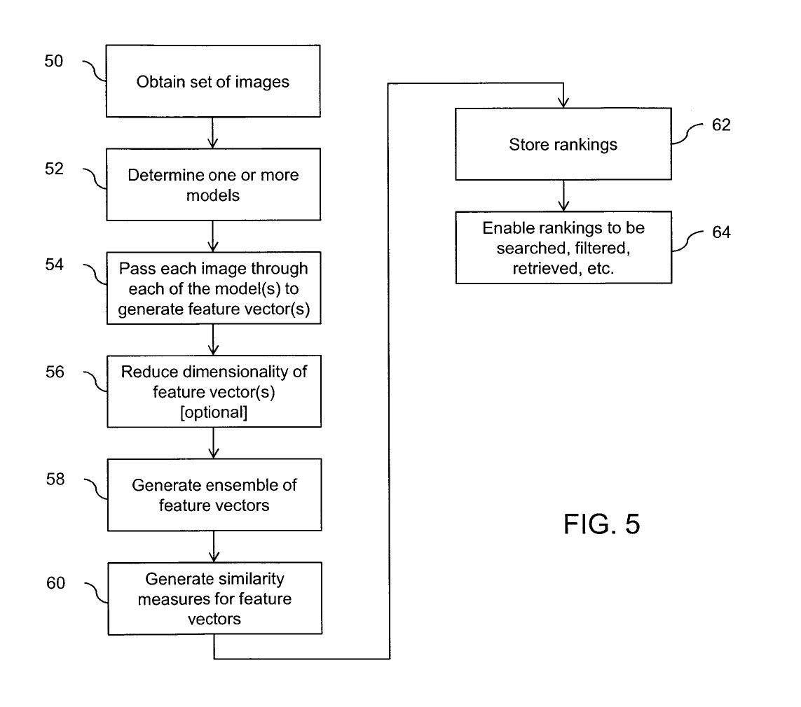

FIG. 5 is a flow chart that outlines the above-described deep learning process using the ConvNets 30. At step 50, the dataset 14 of images is obtained by the DML engine 18. The DML engine 18 then determines one or more ConvNets 30 to be applied to the images at step 52. Each image is passed through each of the ConvNets 30 as indicated above at step 54, to generate the feature vectors 12. Where applicable, the dimensionality of the feature vectors 12 is reduced at step 56, e.g., using a PCA or RBM to generate the new feature vector 38 at step 58, using the ensemble 36. At step 60, the similarity measures 40 for the feature vectors 12 are generated, and the rankings are stored in step 62. It can be appreciated that steps 60 and 62 can be done offline and in advance, or can be done in real-time or quasi-real-time in order to find similar items in a particular application. When stored, these rankings can be made available at step 64 for searching, filtering, retrieval, etc. by the particular application, for example, to generate recommendations as will be exemplified in greater detail below. Accordingly, the DML engine 18 provides a powerful data analytics tool to find and store relevant, granular and extensive features of a product based on what is provided in the images thereof, as well as other information that can assist with determining the relevance of a product.

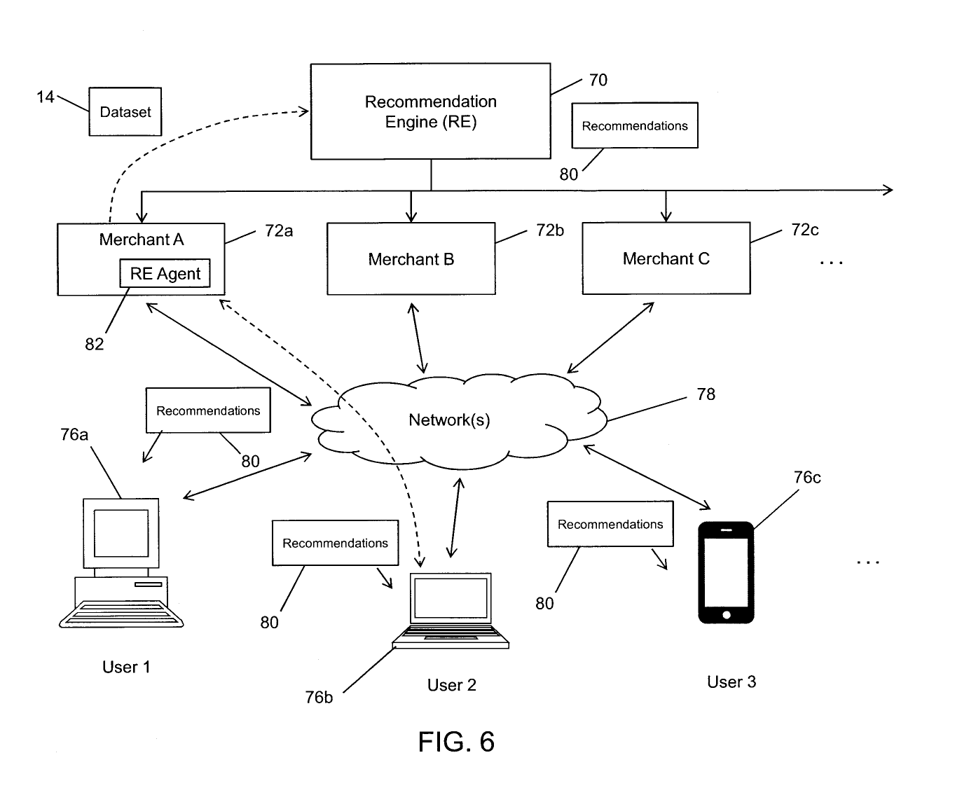

FIG. 6 shows a recommendation engine (RE) 70 that is connected to or otherwise accessible to one or more online merchants 72. In this example, three merchants 72a, 72b, 72c are shown, however, any number of merchants 72 can be connected to the RE 70. The merchants 72 provide or make available to the RE 70, a dataset 14 that includes images and other related or available data for the products being sold through their websites (also referred to herein interchangeably as webstores or online marketplaces, etc.). It can be appreciated that the RE 70 can also take steps to obtain such a dataset 14 from the merchant or another party, e.g., directly from the consumer. For instance, the system can be configured to listen to clicks, searches, time spent in a particular section of a website, scrolling behaviour, etc. For example, the system can use such information to determine if a user is a “hunter” or the type that goes directly to the desired point of interest, a “point person”. There are users that prefer to browse and choose items, and typically do not click on a first option. For these users, the best results can be spread out in the recommendations to accommodate this behaviour. Other users are busy and would prefer the first option(s) to be the best options. That is, user behaviour can be captured to feed the RE 70.

The dataset 14 is used to generate recommendations 80 for users that interact with the merchants 72 using electronic devices 76, such as personal computers (PCs), laptops, tablet computers, smart phones, gaming devices, in-vehicle infotainment systems, etc. In the example shown in FIG. 6, three user devices 76a, 76b, 76c are shown for illustrative purposes, and any number of users, and user device types capable of accessing the merchants 72 via one or more networks 78 (e.g., cellular, Internet, etc.) can benefit from the results generated by the RE 70.

The RE 70 can make available to the merchants 72, a software development toolkit (SDK), application programming interface (API), or other software utility or portal or interface in order to enable a merchant 72 to access and utilize the RE 70. That is, the results generated by the RE 70 can be obtained for the merchants 72 by communicating with the RE 70 to have the recommendations 80 generated in real time; or by using an RE agent 82 that is deployed on or within the merchant's website, in order to provide the recommendations 80 locally without the need to continually make data access calls to the RE 70.

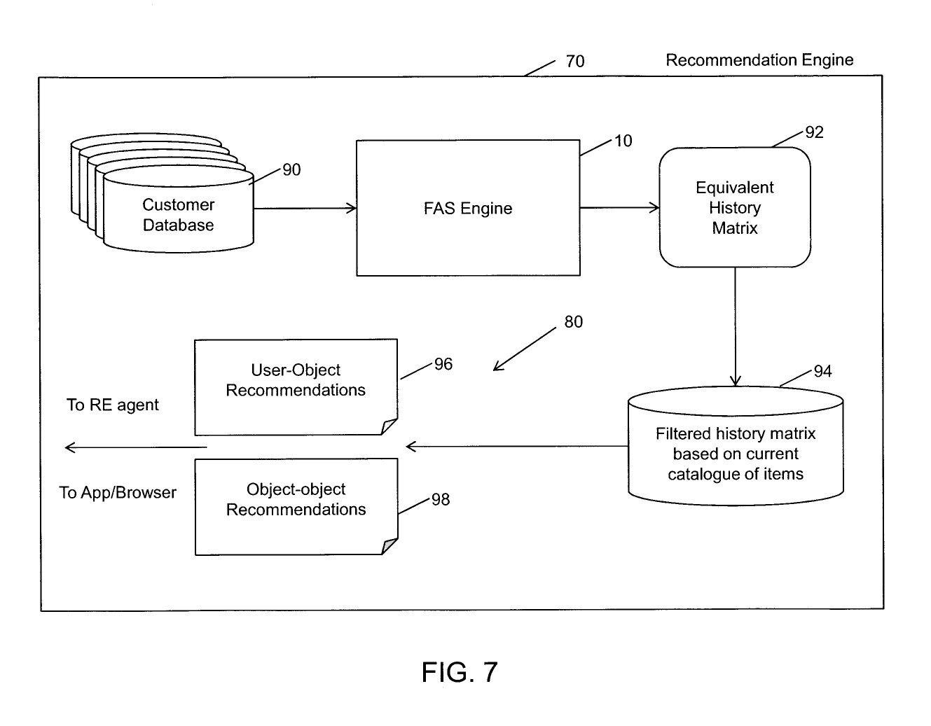

Further detail of the RE 70 is shown in FIG. 7. The RE 70 includes a customer database 90, that includes anonymized purchase and purchase intent data, for example, orders, shopping carts, wishlists (both active and abandoned), other metadata, login information, preferences, cookies, or any other available information that can be associated with a user or their device address, in order to refine, augment, and/or enhance the recommendations. It can be appreciated that the customer database 90 can evolve over time as more interactions with merchants 72 partnered with the RE 70 (or configured to use same) are observed and tracked. In order to provide suitable recommendations that either take into account the user's styles, tastes, preferences, history, etc.; or take into account features, styles, attributes, etc. of certain products that the user may be viewing, the RE 70 utilizes the FAS engine 10. As detailed above, the FAS engine 10 incorporates deep learning, machine learning and, if available and desired, NLP techniques to discover highly dimensional, detailed, granular information about the product being depicted in an image or video on the merchant's website 72, in order to find equivalent, similar, or complementary products having those attributes. It can be appreciated that these similar, equivalent or complementary products can include both same or similar ones of the same product, or complementary products based on, for example, the style elements of the baseline product.

The FAS engine 10 generates and updates an equivalent history matrix 92 that is a matrix containing user interactions on the equivalent/similar/complementary products and is used to increase the density of the data being used. The RE 70 also includes a filtered history matrix based on the current catalog items 94, to filter the entire results to those relevant to the actual items being sold on the merchant's website, since the equivalent history matrix 92 captures both current and historical interactions. This filtered history matrix 94 is used to draw from currently relevant products that can form the basis for recommendations 80 at that time. As such, the FAS engine 10 can reuse the history of interactions with products, even if they no longer exist, to determine currently relevant products that may be of interest at this time. For example, a user may have purchased an item in the past that is no longer sold at that merchant, and this historical interaction can be used to make a current recommendation 80, based on the current inventory.

In this example, the RE 70 can generate both user-object recommendations 96 that recommend particular objects that may be of interest to the user, and object-object recommendations 98 that recommend other objects that share similarities in type, colour, style, etc. based on what the user is currently viewing or searching for.

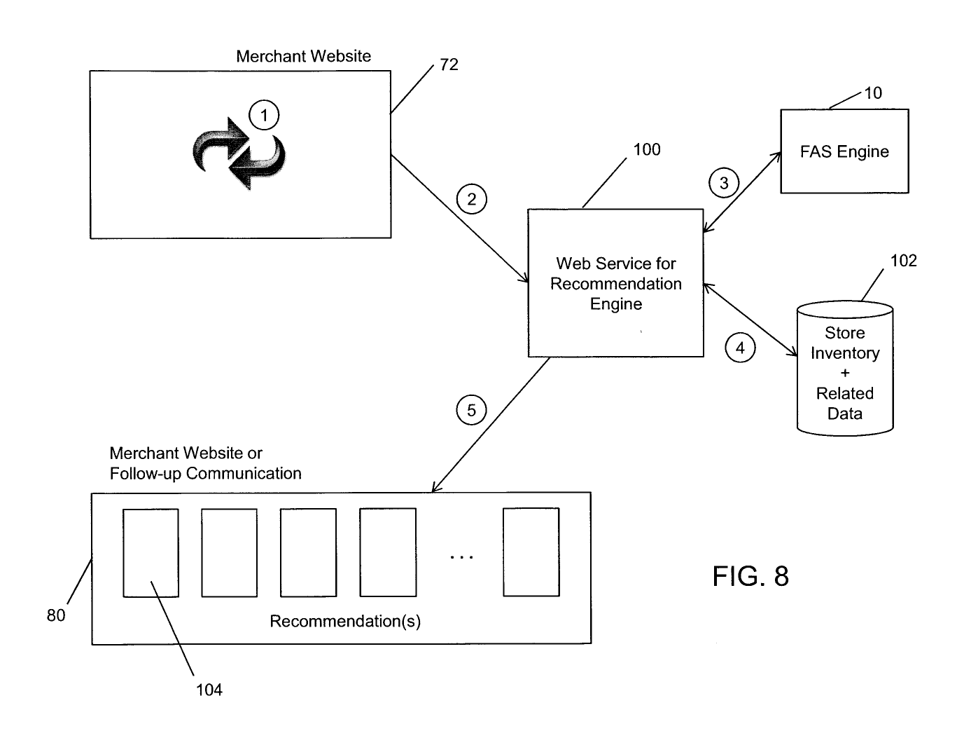

A first scenario for generating a recommendation 80, is depicted in FIG. 8. In this example, a user is interacting with a merchant website 72 at stage 1, e.g., via a user device 76. A web service 100 for the RE 70 tracks these interactions to determine what the user is currently viewing and/or searching for on the merchant website 72. For example, the user may have selected an item from a search and read through product details for some amount of time, added an item to their online shopping cart, etc. This provides an input at stage 2 which is used by the RE 70 to feed the FAS engine 10. The FAS engine 10 can process the input in real-time, or has preferably pre-processed the image data set 14 for that merchant website 72 such that the feature vectors can be searched in stage 3 to find equivalent, similar, or complementary products. For example, the product being viewed may have a particular style elements that is stored in the feature vector 12 for that image, enabling the FAS engine 10 to search for other items within that merchant's inventory that have a similar style. In other examples, the colour, brand, price, etc. can also be considered, whether searchable in the feature vectors 12 or accessible from store inventory and related data 102 in stage 4 stored by the system.

The store inventory and other related data 72 is therefore used, when available, to augment or refine the feature vector data searchable by the FAS engine 10. The web service 100 is then able to assemble a recommendation 80 at stage 5 that includes one or more items 104 that may be of interest to the user, for example, equivalent products of the same style, similar or matching or complementary products, etc. It can be appreciated that the recommendation 80 can be provided in real-time on the merchant website 72 or using a separate media channel, such as email, text message, physical flyer newsletter, etc.

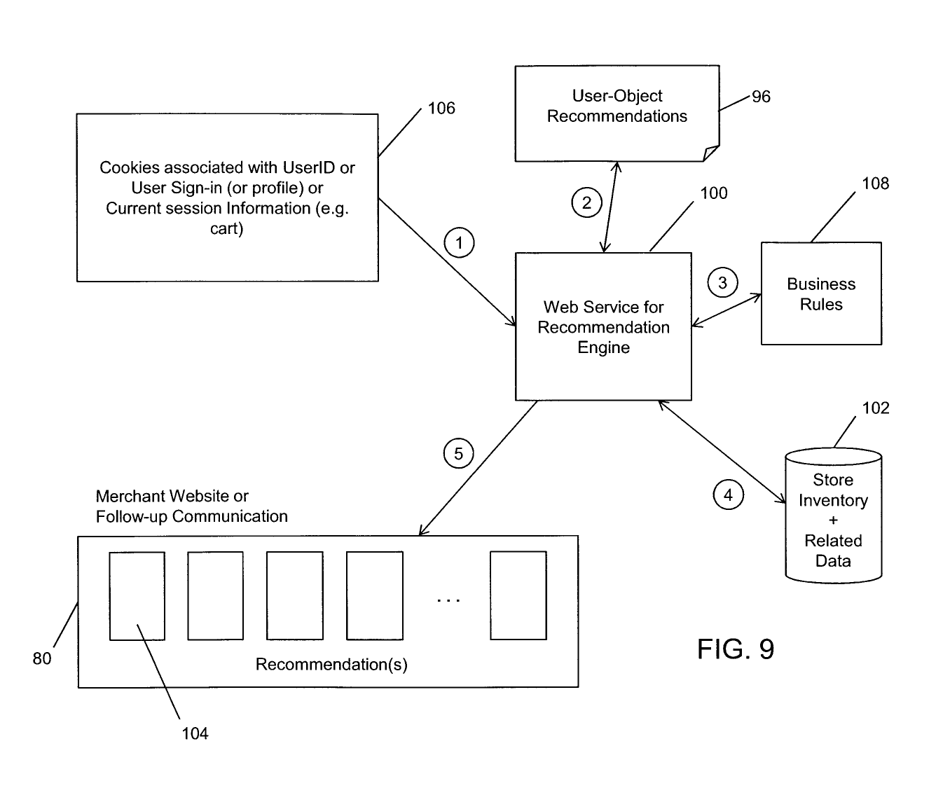

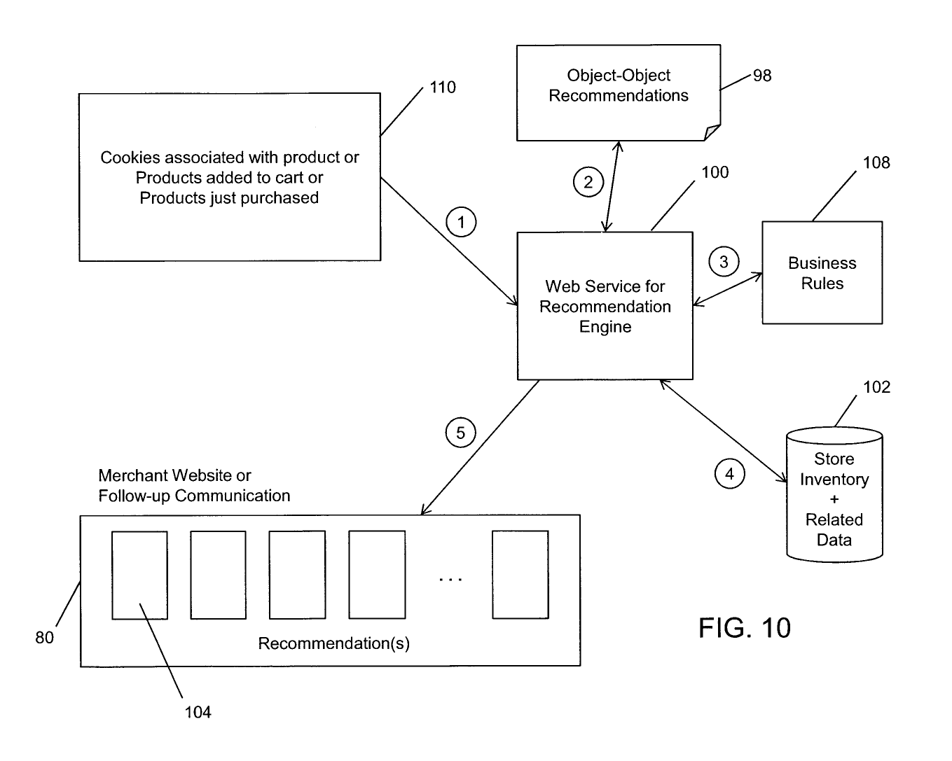

FIGS. 9 and 10 illustrate the generation of user-object and object-object recommendations 96, 98 respectively, as depicted schematically in FIG. 6. Referring first to FIG. 9, user associated data 106 is relied upon in order to generate the user-object recommendations 96. For example, cookies on the user's device 76 may have user information associated with a userID (e.g., if the user is shopping on a sign with a login feature), and/or may have current session information, such as what is in that user's cart. At stage 1, this user associated information 106 is obtained by the webservice 100 to generate the user-object recommendations 96 at stage 2, using the FAS 10, equivalent history matrix 92, and filtered history matrix 94 as illustrated in FIG. 6. The user-object recommendations 96 include a list of items or “objects” that are compatible or may be of interest to that particular user, which may or may not be dependent on a particular product that the user is interacting with. This allows the RE 70 to generate recommendations for users that enter a site in a fresh session, i.e., without having to rely on specific interactions with specific images as was illustrated in FIG. 8. At stage 3, business rules 108 are used to maintain privacy between merchants connected to the system, and to enforce any rule established by the contractual arrangements between the merchants and the system. For example, a User enters site B, and has already entered site A and the system has data associated with the interaction(s) with site A. If site A's contract states that their data cannot be used to recommend a particular product type and/or brand (e.g., athletic shoes) in other stores, an offer or recommendation at site B would filter that brand from the results. At stage 4, the store inventory and related data 102 is used to augment or refine the results based on available information. This can be done to filter using the inventory to show only products currently in existence, and to create “shadow inventory”. Shadow inventory used herein refers to a list of opportunities that a business may be losing because they run out of stock in certain products.

Turning now to FIG. 10, product-related data 110 is gathered by the web service 100 at step 1, and is used to generate the object-object recommendations 98 at stage 2. This allows the system to recommend objects not related by themselves, but by the people that use them. For example, whereas in the example shown in FIG. 5, a pair of boots may lead to recommending another pair of boots or shoes having a similar style elements, in the example shown in FIG. 5, a pair of boots could lead to a recommendation for a particular snow board or skis. Similar to what is shown in FIG. 9, the business rules 108 are used to preserve privacy and contractual obligations associated with merchant relationships, and the store inventory and related data 102 is used to refine the results based on available information.

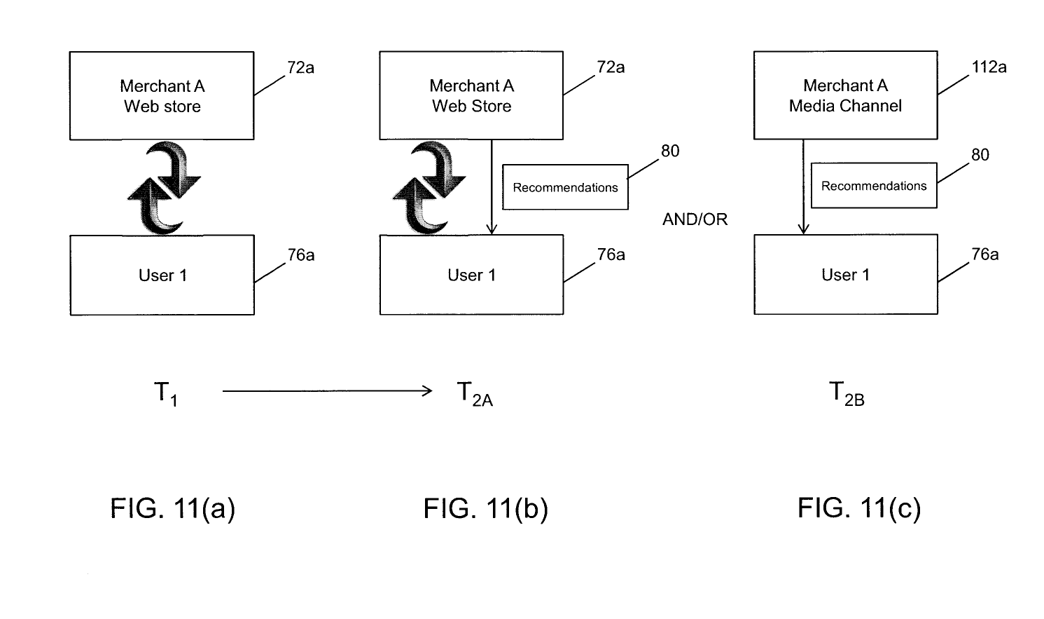

FIGS. 11(a) to 11(c) illustrate the first scenario discussed above, wherein real-time or semi-real-time recommendations 80 are generated based on the user's current activities. As shown in FIG. 11(a), User 1 is interacting with Merchant A's webstore 72a using a particular user device 16a at a first time, T₁. In one alternative, shown in FIG. 11(b), the recommendations 80 are displayed or otherwise provided to User 1 while these interactions are taking place on the user device 76a, at a second time T_{2A}. In another alternative, shown in FIG. 11(c), the recommendations 80 are provided to User 1 at a later time T_{2B}, using a media channel 112a for Merchant A, e.g., electronic newsletters, emails, text messages, etc. In this example, User 1 receives the recommendations 80 at their user device 76a, however, it can be appreciated that any suitable device, or even physical channels such as by post are possible. It can be appreciated that the first scenario depicted in FIGS. 11(a) to 11(c) can also be applicable when User 1 re-enters Merchant A's webstore 72a, that is, wherein time T_{2A} occurs in a subsequent browsing session.

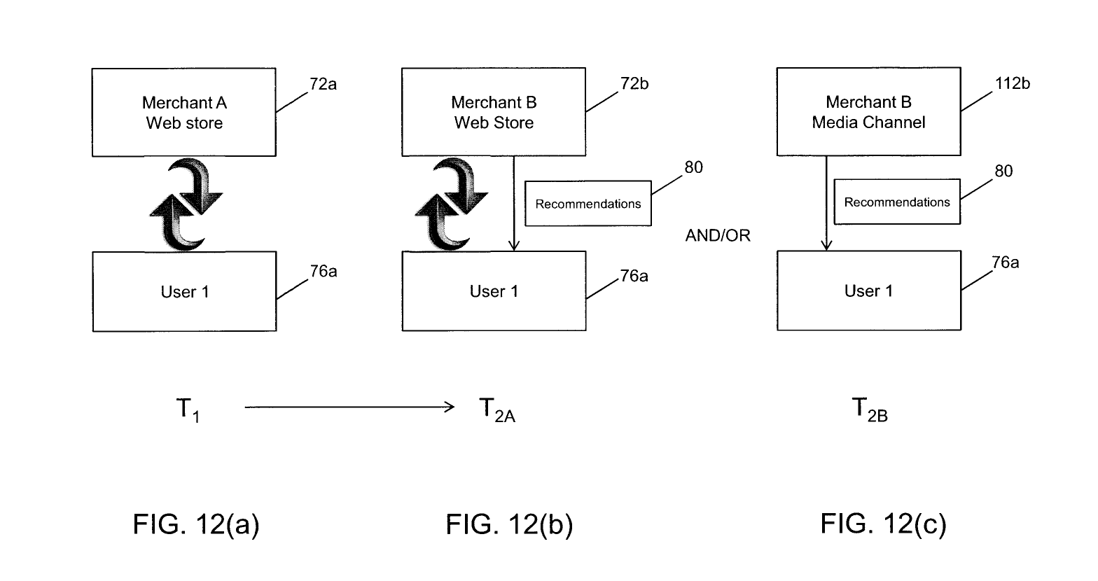

FIGS. 12(a) to 12(c) illustrate a second scenario in which recommendations 80 are provided when accessing Merchant B's webstore 72b, based on previous activities that occurred when accessing Merchant A's webstore 72a. In FIG. 12(a), User 1 interacts with Merchant A's webstore 72a at time T₁, which for example can include purchasing a particular product. Based on this purchase, the RE 70 can generate recommendations 80 that are relevant to User 1 based on products offered by Merchant B. In FIG. 12(b), the recommendations 80 are provided via Merchant B's webstore 72b at time T_{2A}; and in FIG. 12(c), the recommendations 80 are provided via a media channel 112b for Merchant B, similar to what was shown in FIGS. 11(a) to 11(c). The multi-store recommendations 80 can use the FAS engine 10 to find the same, similar, or complementary products. For example, if User 1 purchased product X from Merchant A, when entering Merchant B's webstore 72b, the RE 70 can account for this purchase by filtering out exact matches, if applicable, and provide only similar products for comparison purposes, or complementary products (e.g., handbag of a similar style to a pair of shoes purchased previously). With the DML engine 18, such attributes can be determined in order to provide this flexibility. It can be appreciated that the recommendations 80 provided at Merchant B's webstore 72b can include the exact product previously purchased, e.g., if a sale is on, for price-comparison purposes.

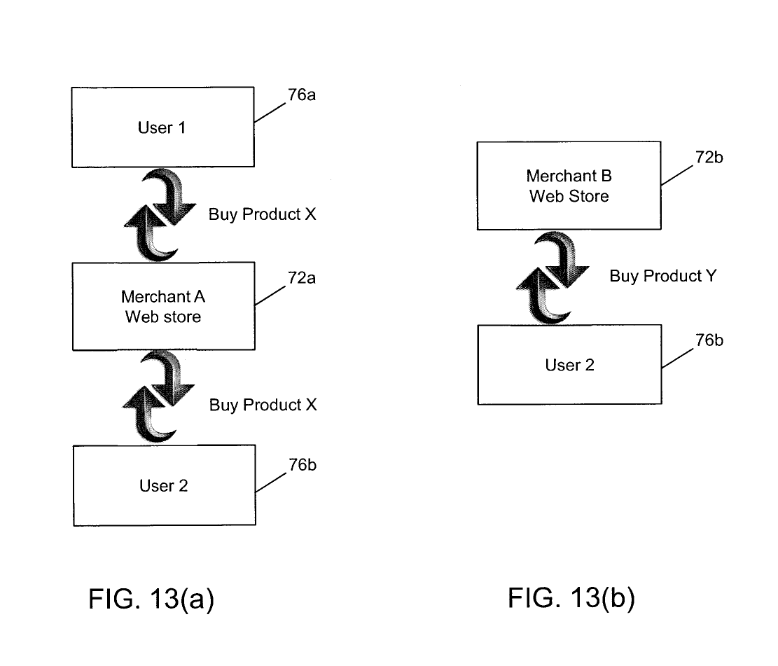

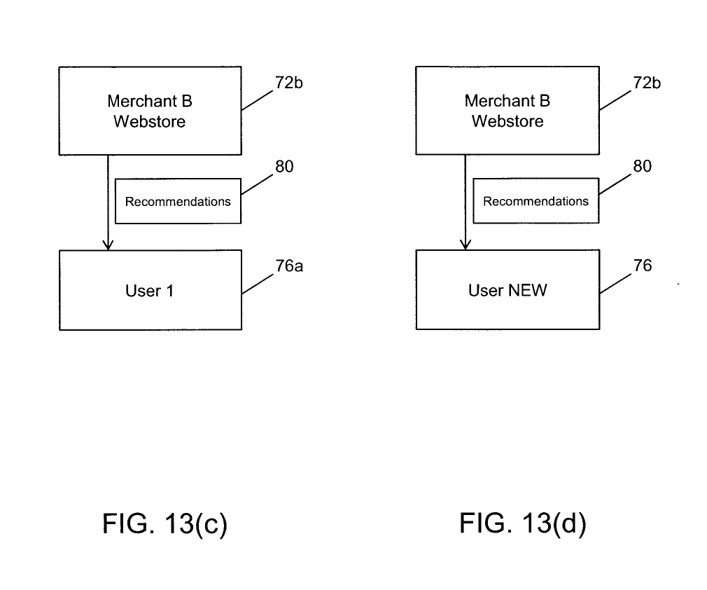

A third scenario is depicted in FIGS. 13(a) to 13(d) wherein similarities between users are used to generate the recommendations 80. In FIG. 13(a) User 1 buys Product X from Merchant A, and User 2 also buys Product X from Merchant A. Based on this (and possibly other determinable) similarities, the RE 70 can assess User 1 and User 2 to be similar or equivalent users. As shown in FIG. 13(b), when User 2 buys Product Y from a different merchant, namely Merchant B in this example, the RE 80 determines that User 1 may also be interested in Product Y due to the similarities between these users. As such, when entering Merchant B's webstore 72b as shown in FIG. 13(c), User 1 can be provided with recommendations 80 that include Product Y, in a “cold start” scenario. These recommendations 80 can be displayed even before User 1 begins searching or browsing the website 72b. Alternatively, Merchant B can send these recommendations 80 to User 1 pre-emptively via a media channel 112b.

FIG. 13(d) illustrates an alternative, wherein an new user “User NEW” using a device 76 accesses Merchant B's webstore 72b. Based on at least a first click or other interaction, the recommendations 80 can be provided to this new user in an extreme “cold start” scenario.

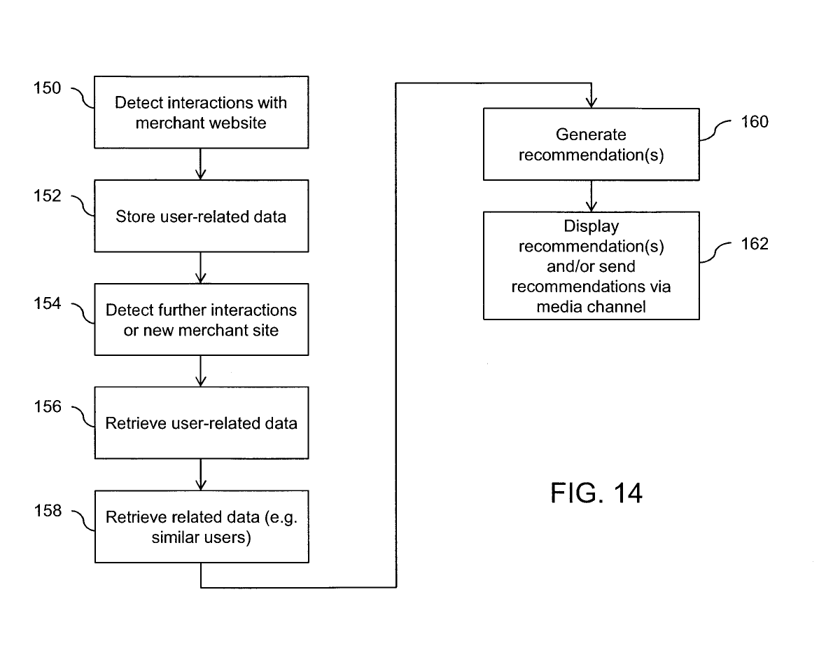

In general, as shown in FIG. 14, the RE 10 can generate recommendations 80 in either real-time or otherwise, by detecting interactions with merchant websites 72 at step 150, and storing user-related data at step 152. The interactions with a merchant site 72 and collection of any available (or determinable) user-related data enables the RE 80 to generate recommendations 80 based on current activities and/or refine or enhance recommendations 80 in subsequent interactions. As indicated above, this data can also be used to determine similar or equivalent users to further enhance the recommendations 80. At step 154 the RE 70 detects further interactions on the same merchant site 72 or the same (or different) user entering a new merchant site. If available, user-related data is obtained at step 156 and any other related or relevant data, such as similar users at step 158. The RE 70 then generates one or more recommendations 80 at step 160 and displays the recommendations 80 at step 162 and/or sends a recommendation 80 via a media channel 112. It can be appreciated that any available data can be used to filter and enhance recommendations 80 such that as a user interacts with a merchant website 72 or moves between merchant websites 72, relevant recommendations 80 derived from deep learning are available to be displayed or otherwise delivered. The RE 70 can operate independently or in conjunction/integrated with the merchant website 72 to gain access to any and all relevant data related to products and users, as well as the image data sets 14 that allow deep learning to be applied in order to more accurately determine equivalent, similar, related, and complementary products to populate the recommendations 80.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the recommendation engine 10, merchant site 12, user device 16, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of analyzing features associated with objects, the method comprising:
obtaining one or more images associated with corresponding one or more objects;
passing each image through a plurality of models to generate feature vectors for each object;
combining feature vectors for each object when multiple feature vectors are produced;
generating similarity measures for the feature vectors; and
storing the feature vectors to enable the features to be searched, filtered and/or retrieved.

2. The method of claim 1, wherein the plurality of models comprise convolution neural networks (CNNs).

3. The method of claim 1, further comprising receiving a query or request based on a first object, and searching stored feature vectors to return an equivalent, similar, or complementary object.

4. The method of claim 3, wherein the equivalent, similar, or complementary object is determined based on a style associated with both the first object and the complementary object.

5. The method of claim 1, further comprising using an equivalent history matrix to generate a recommendation based on a current catalogue of items.

6. The method of claim 5, further comprising analyzing additional data related to an object using a natural language processor (NLP).

7. The method of claim 1, further comprising detecting an interaction between a user and a first merchant site and generating a recommendation related to the first merchant site using the stored feature vectors.

8. The method of claim 7, wherein the recommendation is provided in the first merchant site or using a different media channel.

9. The method of claim 1, further comprising further comprising detecting an interaction between a user and a first merchant site and generating a recommendation related to a second merchant site using the stored feature vectors.

10. The method of claim 9, wherein the recommendation is provided in the second merchant site or using a different media channel.

11. The method of claim 1, further comprising detecting interactions between a first merchant site and a plurality of users; and generating a recommendation for one of the users based on a similarity between at least two of the users.

12. The method of claim 11, wherein the similarly relates to a similar product being purchased.

13. A method of generating a recommendation based on online interactions with one or more merchants, the method comprising:
detecting one or more online interactions by an online user with a merchant;
storing user-related data based on the detected interactions;
detecting further online interactions with the merchant or a new merchant;
retrieving the user-related data and additional data associated with the online user and/or one or more similar users;
generating one or more recommendations using the retrieved data and data stored for objects based on one or more images associated with corresponding one or more objects; and
displaying the one or more recommendations or sending the one or more recommendations via a medial channel.

14. A non-transitory computer readable medium comprising computer executable instructions for analyzing features associated with objects, comprising computer executable instructions for:
obtaining one or more images associated with corresponding one or more objects;
passing each image through a plurality of models to generate feature vectors for each object;
combining feature vectors for each object when multiple feature vectors are produced;
generating similarity measures for the feature vectors; and
storing the feature vectors to enable the features to be searched, filtered and/or retrieved.

15. A non-transitory computer readable medium comprising computer executable instructions for generating a recommendation based on online interactions with one or more merchants, comprising computer executable instructions for:
detecting one or more online interactions by an online user with a merchant;
storing user-related data based on the detected interactions;
detecting further online interactions with the merchant or a new merchant;
retrieving the user-related data and additional data associated with the online user and/or one or more similar users;
generating one or more recommendations using the retrieved data and data stored for objects based on one or more images associated with corresponding one or more objects; and
displaying the one or more recommendations or sending the one or more recommendations via a medial channel.

16. A system comprising a processor, memory, and an interface with a plurality of merchants, the memory comprising computer executable instructions for analyzing features associated with objects, comprising computer executable instructions for:
obtaining one or more images associated with corresponding one or more objects;
passing each image through a plurality of models to generate feature vectors for each object;
combining feature vectors for each object when multiple feature vectors are produced;
generating similarity measures for the feature vectors; and
storing the feature vectors to enable the features to be searched, filtered and/or retrieved.

17. A system comprising a processor, memory, and an interface with a plurality of merchants, the memory comprising computer executable instructions for generating a recommendation based on online interactions with one or more merchants, comprising computer executable instructions for:
detecting one or more online interactions by an online user with a merchant;
storing user-related data based on the detected interactions;
detecting further online interactions with the merchant or a new merchant;
retrieving the user-related data and additional data associated with the online user and/or one or more similar users;
generating one or more recommendations using the retrieved data and data stored for objects based on one or more images associated with corresponding one or more objects; and
displaying the one or more recommendations or sending the one or more recommendations via a medial channel.
